(19) United States
(12) Patent Application Publication
(10) Pub. No.: US 2012/0066087 A1
(43) Pub. Date: Mar. 15, 2012

(54) Generating product recommendations

(75) Inventor: Wei Zhang, Hangzhou (CN)

(73) Assignee: Alibaba Group Holding Limited

(21) Appl. No.: 13/199,966

(22) Filed: Sep. 13, 2011

(30) Foreign Application Priority Data
Sep. 15, 2010 (CN) 201010285560.8

(51) Int. Cl. G06Q 30/00

(52) U.S. Cl. 705/26.7

(57) ABSTRACT

Generating product recommendations, including: receiving an indication of a user operation associated with a product; determining a plurality of associated products for the product associated with the user operation; determining a plurality of comprehensive correlation degrees corresponding to the plurality of associated products, wherein each of the plurality of comprehensive correlation degrees corresponds to an association between the product and one of the plurality of associated products, wherein determining a comprehensive correlation degree corresponding to the product and an associated product includes: determining a product information association degree corresponding to the product and the associated product; and determining an attribute information association degree corresponding to the product and the associated product; selecting a subset of the plurality of associated products based at least in part on a condition associated with the corresponding plurality of comprehensive correlation degrees; and presenting the subset of the plurality of associated products.

### CROSS REFERENCE TO OTHER APPLICATIONS

This application claims priority to People's Republic of China Patent Application No. 201010285560.8 entitled INFORMATION PROVIDING METHOD AND DEVICE AND COMPREHENSIVE CORRELATION DEGREE DETERMINATION METHOD AND DEVICE filed Sep. 15, 2010 which is incorporated herein by reference for all purposes.

### FIELD OF THE INVENTION

The present disclosure involves the field of information processing; in particular, it involves a technique of generating product recommendations.

### BACKGROUND OF THE INVENTION

Users can visit electronic commerce websites to purchase products that are available at the websites. To purchase a product, a user can utilize, for example, the electronic fund settlement system.

Sometimes when a user of an electronic commerce website browses the products at the website, the website provides to the user one or more product recommendations that may be strongly correlated to the products that are browsed by the user. Product recommendations can make it convenient for users to find products that they are interested in amidst a large inventory of products available at the website.

FIGS. 1A and 1B shows an example of a process by which conventional techniques use to provide product recommendations:

At 102, the product information for one or more products purchased at a time by a user is included into a product transaction. A product transaction includes product information for one or more products, and all product transactions are included in an aggregated product transaction set. Product information can be, but is not limited to, product identifier information.

At 104, the product information of any product that has been purchased at the electronic commerce website is included into a candidate frequent 1-itemset. An aggregated set of candidate frequent 1-itemsets includes all of the candidate frequent 1-itemsets. A 1-itemset refers to a set of products that includes only one type of product.

At 106, for each candidate frequent 1-itemset, the ratio of the number of product transactions that include the candidate frequent 1-itemset to the total number of product transactions in the aggregated set of product transactions is determined as the relative support value for the candidate frequent 1-itemset.

At 108, within the aggregated set of candidate frequent 1-itemsets, candidate frequent 1-itemsets whose relative support value is not less than a first specified threshold value are determined as confirmed frequent 1-itemsets. An aggregated set of confirmed frequent 1-itemsets includes all of the confirmed frequent 1-itemsets.

At 110: the confirmed frequent 1-itemsets included in the aggregated set of confirmed frequent 1-itemsets are combined into pairs to form candidate frequent 2-itemsets. An aggregated set of candidate frequent 2-itemsets includes all of the candidate frequent 2-itemsets. A 2-itemset refers to a set of products that includes two types of product.

At 112, for each candidate frequent 2-itemset, the ratio of the number of product transactions that include the candidate frequent 2-itemset to the total number of product transactions included in the aggregated set of product transactions is determined as the relative support value for the candidate frequent 2-itemset.

At 114, from the aggregated set of candidate frequent 2-itemsets, candidate frequent 2-itemsets whose relative support value is not less than a second specified threshold value are determined as the confirmed frequent 2-itemsets. An aggregated set of confirmed frequent 2-itemsets includes all of the confirmed frequent 2-itemsets.

At 116, for each confirmed frequent 2-itemset {A, B}, a first candidate correlation rule for A and B (also referred to as A→B, wherein A is the antecedent. and B is the subsequent) and a second candidate correlation rule for B and A (also referred to as B→A, wherein B is the antecedent and A is the subsequent) are generated. Each of the antecedent and the subsequent refer to one of the two products in the confirmed frequent 2-itemset.

At 118, for each of the first and second candidate correlation rules, the ratio of the relative support value of the corresponding frequent 2-itemset to the relative support value of the antecedent is determined as the confidence level of the antecedent and subsequent included in the candidate correlation rule. The relative support value of the antecedent can be the relative support value as determined for the antecedent in its 1-itemset.

At 120, from all candidate correlation rules, correlation rules for which the confidence levels of the antecedent and the subsequent are not less than a third specified threshold value are determined to be the confirmed correlation rules. An aggregated set of correlation rules includes all of the correlation rules.

At 122, later, for a user operation at the electronic commerce website that is associated with product A, then all confirmed correlation rules for which A is the antecedent are determined from among the aggregated set of confirmed correlation rules, and the subsequents included in all of the determined confirmed correlation rules are selected to form a candidate recommendation list for product A;

At 124, the individual subsequents included in the candidate recommendation list are ranked in order from highest to lowest based at least in part on the confidence levels of their respective corresponding correlation rules.

At 126, the first N subsequents on the candidate recommendation list are selected to form a recommendation list for product A.

At 128, the recommendation list is present.

As described above, the conventional process of recommending products primarily recommends products that were previously purchased in transactions that included a product that is currently being browsed by a user, i.e., such product recommendations are based on the correlation between product information. However, some products, despite the low probability that they were once purchased during the same transaction as a product that is currently browsed by the user, may have some attributes in common with the product that is currently browsed by the user. Thus, the product information for these products are more correlated than how much the conventional techniques typically attribute to them and are desirable to be considered in generating product recommendations.

### BRIEF DESCRIPTION OF THE DRAWINGS

Various embodiments of the invention are disclosed in the following detailed description and the accompanying drawings.

FIGS. 1A and 1B shows an example of a process by which conventional techniques use to provide product recommendations.

FIG. 2 is a diagram showing an embodiment of a system for generating product recommendations.

FIG. 3 is a flow diagram showing an embodiment of a process of generating product recommendations.

FIG. 4 is a flow diagram showing an embodiment of a process of generating comprehensive correlation degrees.

FIG. 5 is a flow diagram showing an embodiment of a process of generating product recommendations.

FIG. 6 is a diagram showing an embodiment of a system for generating product recommendations.

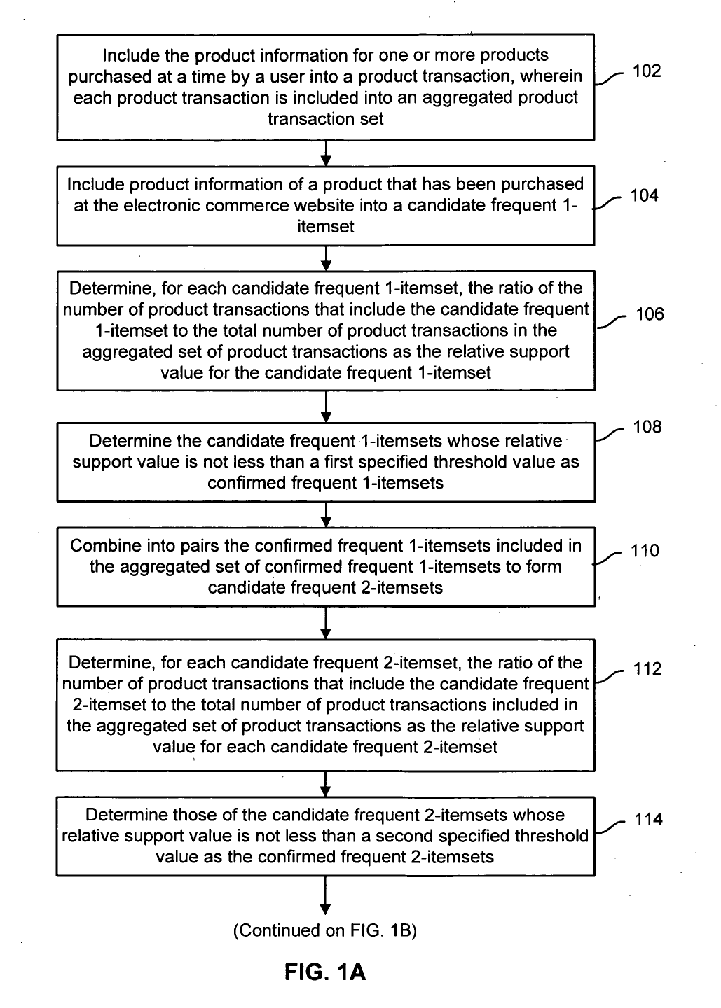

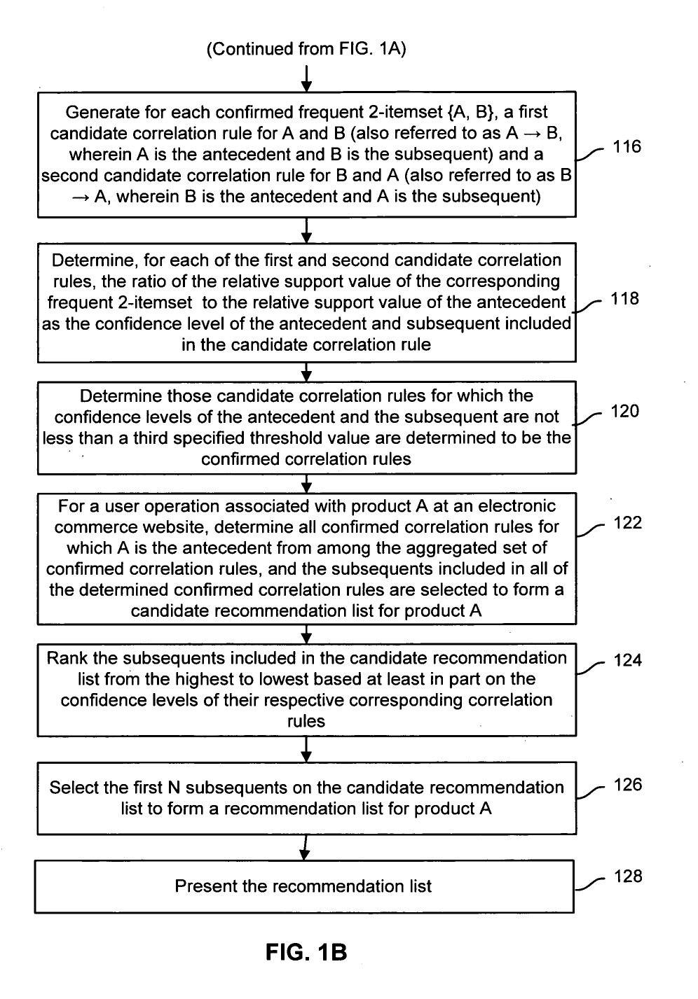

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some conventional techniques rely on confidence levels to select and generate product recommendation information to the user. For example, if a user buys a certain product, such as a printer ink cartridge, on a periodic basis, then it is possible that within the same period of time in which the user buys a printer ink cartridge, the user will also buy another product that may not be related the printer ink cartridge (e.g., a pillow). Although, even though there is little similarity between the printer ink cartridge and the pillow products that were purchased around the same time, by using the conventional technique of using only confidence levels to generate product recommendations, the unrelated products of a printer ink cartridge and a pillow could still be considered to be associated with each other. Then one of the products could be recommended to the user that performs a user operation associated with the other product because due to their having been purchased by the user around the same time, their confidence levels could mistakenly indicate a strong correlation between the two products.

Unlike the conventional techniques, the techniques disclosed in the present application describe using both an association degree of product information and an association degree of attribute information, which are determined based on support values and reliability values (instead of just confidence levels). As used herein, a reliability value is the difference between a confidence level and the relative support value of a product, which helps to prevent the situations where two, completely unrelated products are taken to be highly correlated with each other just because they had been purchased at around the same time at some point.

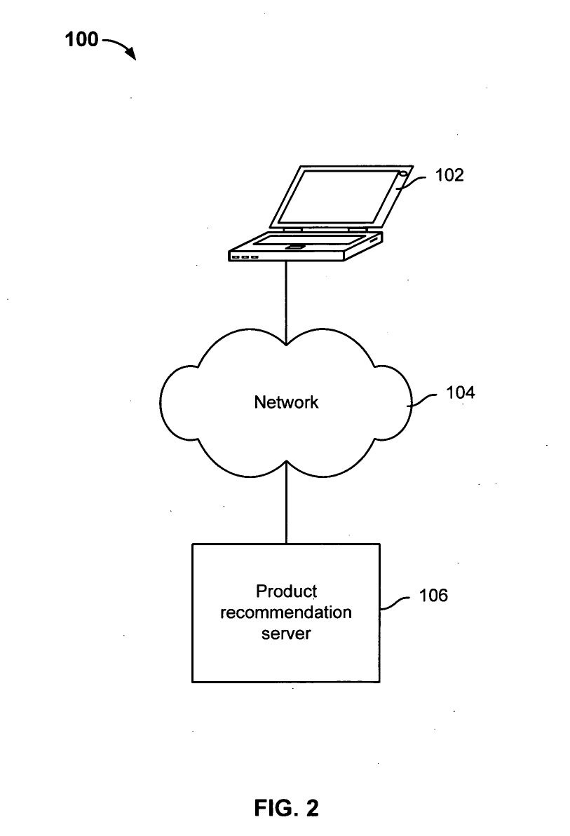

FIG. 2 is a diagram showing an embodiment of a system for generating product recommendations. System 200 includes device 102, network 104, and product recommendation server 106. Network 104 can include one or more of high speed data networks and/or telecommunication networks. In various embodiments, product recommendation server 106 is associated and/or is a component of an electronic commerce website.

Device 102 is configured to access, receive information, and submit information to an electronic commerce website associated with product recommendation server 106. In various embodiments, a web browser application is configured on device 102 to enable a user of device 102 to interact with the electronic commerce website. Examples of device 102 include a laptop computer, a desktop computer, a mobile device, a smart phone, a tablet device, or any type of computing device. For example, a user can use device 102 to purchase products at the electronic commerce website. A user can also use device 102 to perform a user operation (e.g., browsing, submitting feedback) with respect to a product at the electronic commerce website.

Product recommendation server 106 is configured to store information of product transactions (e.g., at an associated database) associated with products purchased by one or more users at the electronic commerce website. In various embodiments, product recommendation server 106 is configured to analyze a set of stored product transactions (e.g., associated with a predetermined period of time) to generate and store statistics-based correlations (i.e., comprehensive correlation degrees) between each product in the set of stored product transactions and each of its associated product. A comprehensive correlation degree takes into account information between the historical likelihood that a second product had previously been purchased with a first product that a user is currently showing interest in (e.g., the user is currently performing a user operation with respect to this product) and the correlation between the attributes of the first and second products. Further details regarding analyzing product transactions and generating comprehensive correlation degrees are discussed below.

Product recommendation server 106 is also configured to generate product recommendations. In some embodiments, using device 102, a user performs a user operation associated with a product at the electronic commerce website and an indication of the user operation is sent to product recommendation server 106. In response, product recommendation server 106 is configured to generate a predetermined number of product recommendations for the user based on comprehensive correlation degrees of products associated with the product of the user operation. In some embodiments, the product recommendations are then displayed at device 102.

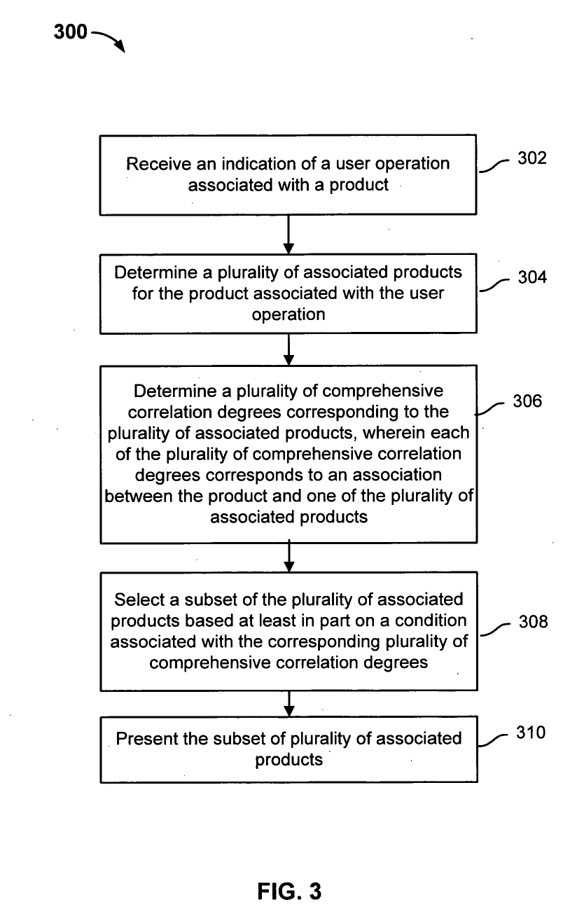

FIG. 3 is a flow diagram showing an embodiment of a process of generating product recommendations. In some embodiments, process 300 can be implemented at system 200.

At 302, an indication of a user operation associated with a product is received.

In various embodiments, a user performs a user operation at an electronic commerce website. Examples of the user operation can include browsing a webpage associated with the product at the website (e.g., using a web browser), purchasing the product at the website, or submitting feedback associated with the product at the website. For example, if a user is browsing the webpage associated with the product of a printer ink cartridge, then an indication of a user operation associated with a printer ink cartridge is received.

At 304, a plurality of associated products are determined for the product associated with the user operation.

In some embodiments, product information may be, but is not limited to, product identifiers. For example, a product identifier can be associated with one type of product that is available for sale at an electronic commerce website. At certain e-commerce websites, and particularly C2C (consumer-to-consumer) websites, B2B (business-to-business) websites with multiple businesses, or B2C (business-to-consumer) websites, the number of products that a user may purchase at a time varies. For example, at some websites, a user can only purchase one product during each checkout and while at some other websites, a user can purchase more than one product during each checkout session. So, a product transaction as used herein may be determined based on various ways (instead of a product transaction only referring to product(s) that are purchased during one checkout session since this could change from website to website). One example way to define a product transaction includes including purchases that are purchased by a user over a predetermined period of time (e.g., as set by a network administrator) into one product transaction. So, in this definition, a product transaction can include individual products purchased over the course of multiple checkout sessions. Another example way of defining a product transaction includes including certain products that are associated with various types of user behavior that occur over a predetermined period of time into one product transaction. As used herein, user behavior includes at least one type of a network operation associated with a user's interaction with a (e.g., electronic commerce) website such as, for example, user behavior to confirm purchases, user behavior to add product information to a favorites folder, and user behavior to click browsed product information. Yet another example way of defining a product transaction includes including only products that each has met a predetermined condition over a predetermined period of time into one product transaction. For example, a predetermined condition can be a number of times that a product is purchased (e.g., so that only a product that has been purchased twice during the predetermined period of time can be included in the product transaction). Also, for example, a predetermined condition can be a certain ranking (e.g., associated with a type of user behavior) of a product. Specifically, products that were purchased over the predetermined period of time can be ranked chronologically (e.g., the products that were purchased earlier in time will be ranked higher than products that were purchased later in time). Then a certain number of products from the beginning of the ranked list can be included in the product transaction. By defining the product transaction in these exemplary ways, even if user only purchases one type of product each time (i.e., at each checkout session), it is possible for a product transaction to include information on multiple products. The predetermined period of time associated with a product transaction can be set as, but is not limited to, one week, one month, one quarter of a year, half a year, one year, for example. For example, assume the products purchased by user a in the first quarter of a year are A, B, C, and D, then the corresponding product transaction would include information for the four products A, B, C, and D. If a product transaction storage format is <user identifier, season identifier, product identifier>, then the product transaction as mentioned above could be stored as <user a, first fiscal quarter, A, B, C, D>.

If information on two products is included within the same product transaction, then the correlation of these two products is determined. For example, if a certain product transaction includes products A and B, then A and B are correlated; that is, A is an associated product of B, while B is an associated product of A. Also, for example, for the product transaction represented by <user a, first fiscal quarter, A, B, C, D>, products B, C, and D are associated products of product A; products A, C, and D are associated products of product B, products A, B, and D are associated products of C; and products A, B, and C are associated products of product D.

In various embodiments, an aggregated set of product transactions obtained over a predetermined period of time is analyzed to determine a comprehensive correlation degree between each unique type of product in the aggregated set of product transactions with at least some of the other types of products (e.g., its associated products) in the aggregated set of product transactions.

Correlating associated products can be determined in advance for each individual product of a product transaction; then, after the indication of the user operation associated with a product is received, the associated product information for that product can be determined using the correlation information that has already been determined offline.

At 306, a plurality of comprehensive correlation degrees corresponding to the plurality of associated products is determined, wherein each of the plurality of comprehensive correlation degrees corresponds to an association between the product and one of the plurality of associated products.

In some embodiments, the comprehensive correlation degree is computed offline for the product associated with the user operation and each of the associated products in the aggregated set of product transactions. As used herein, an “associated product” of a product is a product that appears in at least one of the same product transaction as the product with which it is associated.

In various embodiments, the comprehensive correlation degree between a product (associated with the user operation) and each of its associated products is determined based on the product information association degree (as explained below) and the attribute information association degree (as explained below) between the product and each of its associated products. So, prior to determining the comprehensive correlation degree of a product and an associated product, the product information association degree and the attribute information association degree between the product and associated product are determined. Once the product information association degree and attribute information association degree are determined for the product and an associated product, the comprehensive correlation degree can be determined using the following techniques, for example: multiplying the product information association degree and attribute information association degree, adding the product information association degree and attribute information association degree, attributing a weight coefficient to each of the product information association degree and attribute information association degree and then adding the weighted values together, or attributing a weight coefficient to each of product information association degree and attribute information association degree and then averaging the weighted values.

For example, if product B is product A's associated product, the product information association degree between A and B can be represented as S_{AB}, and the attribute information association degree can be represented as T_{AB}, then the comprehensive correlation degree between A and B (P_{AB}) can be determined as P_{AB}=S_{AB}+T_{AB}, P_{AB}=(S_{AB}+T_{AB)/}2, or P_{AB}=a1×S_{AB}+a2×T_{AB}, where a1 and a2 are weight coefficients, and the weight coefficients a1 and a2 can be set (e.g., by a network administrator) based on the respective importance of the product information association degree and the attribute information association degree. For merely exemplary purposes, the comprehensive correlation degree for a product and an associated is described to be determined to by multiplying the product information association degree and attribute information association degree of the product and the associated product information for the remainder of the application, even though in practice, the comprehensive correlation degree can be also determined in other ways.

In various embodiments, the product information association degree and the associated product information association degree of a product associated with a user operation and another product that is included in at least one of the same product transactions as the product of the user operation (an associated product) can be determined as follows:

(1) The product information association degree can be determined, for example, as follows:

First, the support value (as explained below) is determined between the product and the associated product. Next, the reliability value (as explained below) is determined between the product and the associated product. The, the support value and reliability values are multiplied and used as the product information association degree for the product and the associated product. For example, if B is A's associated product, and the support value between A and B can be represented as R_{AB}, and the reliability value can be represented as Q_{AB}, and so the product information association S_{AB} degree between A and B can be determined by S_{AB}=R_{AB}×Q_{AB}.

The support value R_{AB} between the product and the associated product can be either the absolute support value or the relative support value. The absolute support value between the product and the associated product is determined as the number Z₁ of product transactions of the aggregated set of product transactions that include both of the product and the associated product. The relative support value between the product and associated product is determined as the ratio of the number Z₁ of product transactions that include both of the product and the associated product (i.e., the absolute support value) to the total number Z₂ of product transactions of the aggregated set of product transactions.

The reliability value Q_{AB} between the product and the associated product is determined to be the difference between the confidence level X_{AB} of the product and the associated product and the relative support R_{B′} of the associated product. The confidence level X_{AB} between the product and the associated product is the ratio of the absolute support value R_{AB} between the product and the associated product and the absolute support value R_{A} for the product; or the ratio of the relative support value R_{AB} between the product and the associated product to the number of product transactions of the aggregated set of product transactions that include the product; the relative support value R_{A′} for the product is the ratio of the number of product transactions of the aggregated set of product transactions that include the product to the total number of product transactions of the aggregated set of product transactions; the absolute support value R_{B} for the associated product is the number of product transactions of the aggregated set of product transactions that include the associated product; the relative support R_{B′} for the associated product is the ratio of the number of product transactions that include the associated product information to the total number of product transactions of the aggregated set of product transactions.

(2) The attribute information association degree can be determined, for example, as follows:

Each product can have a plurality of types of attributes, for example, effect attributes, brand attributes, place of origin attributes, etc. In some embodiments, the attribute information association degree between a product and an associated product can be determined by multiplying the attribute information association degrees of the one or more of attributes of the product and associated product. The attribute information association degrees of the plurality of attributes can be found by determining an attribute information association degree between an attribute of one type of the product and an attribute of the corresponding type of the associated product individually first. As used herein, “an attribute of the product and a corresponding attribute of the associated product” can be used interchangeably with “an attribute of the product and an attribute of the corresponding type of the associated product.” So, attributes of the same type associated with a product and an associated product can be compared for correlation. For example, a brand attribute of a product can be compared with a brand attribute of the associated product.

For a given attribute of the product and a corresponding attribute of the associated product, to determine the attribute information association degree between the two, the support value and the reliability value between the given attribute of the product and a corresponding attribute of the associated product are first determined. Then the support value and then reliability value of this given type of attribute of the product and the corresponding type of attribute of the associated product are multiplied to yield the attribute information association degree between this corresponding pair of attributes for the product and the associated product. For example, if B is A's associated product, assume that the support value for the effect attributes of A and B is W_{AB1} and the reliability value for the effect attributes of A and B is U_{AB1}; assume that the support value of the brand attributes of A and B is W_{AB2} and the reliability value for the brand attributes of A and B is U_{AB2}; assume that the support value of the origin attributes of A and B is W_{AB3} and the reliability value of the origin attributes of A and B is U_{AB3}, so then the attribute information association degree between A and B is T_{AB}=W_{AB1}×U_{AB1}×W_{AB2}×U_{AB2}×W_{AB3}×U_{AB3}.

In some embodiments, a product transaction, with respect to its attributes, can be transformed to become an attribute information transaction. In some embodiments, to transform a product transaction into an attribute information transaction includes representing each attribute of the product transaction by the identifier/category of attribute with which it is associated. For example, if a product transaction can be represented by <user a, first fiscal quarter, A, B, C, D>, where A, B, C, D were attributes, then assume that is it determined that A falls under attribute category 1, B falls under attribute category 2, C falls under attribute category 3, and D falls under attribute category 4 (e.g., where attribute categories 1, 2, 3, and 4 are associated with the same type of attributes such as brand attributes). Then the resulting attribute transaction information will be <user a, first fiscal quarter, category 1, category 2, category 3, category 4>. If at least two attributes of a product transaction are the same such as, for example, when A falls under attribute category 1, B falls under attribute category 1, C falls under attribute category 1, D and falls under attribute category 2, then after transformation of the product transaction, the attribute transaction will be <user a, first fiscal quarter, category 1, category 1, category 1, category 2>. In some embodiments, there are as many attribute transactions in an aggregated set of attribute transactions as there are product transactions in an aggregated set of product transactions.

In some embodiments, the support value used to determine the attribute information association degree between the product and the associated product can be either absolute support value or relative support value.

The absolute support value W_{AB1} between an attribute of a product and the corresponding attribute of an associated product is the number Z₃ of attribute transactions of the aggregated set of attribute transactions that simultaneously include attribute of the product and the corresponding attribute of the associated product; the relative support value W_{AB1′} between the attribute of the product and the corresponding attribute of the associated product is the ratio of the absolute support value between the attribute of the product and the corresponding attribute of the associated product W_{AB1} and the total number Z₄ of attribute transaction of the aggregated set of attribute transactions.

When determining the absolute support value, if the attribute of the product and the corresponding attribute of the associated product are the same, then an attribute transaction that includes the attribute information must include two of the same attributes, that is to say, the respective product transaction must include at least two non-identical products that correspond to the same attribute information.

The reliability value U_{AB} between the attribute of a product and the corresponding attribute of an associated product is the difference between the confidence level Y_{AB} of the attribute of the product and the corresponding attribute of the associated product and the relative support value W_{B1′} of the corresponding attribute of the associated product. The confidence level Y_{AB} is the ratio of the absolute support value W_{AB1} between the attribute of the product and the corresponding attribute of the associated product and the absolute support value W_{A1} of the attribute of the product; or it is the ratio of the relative support value W_{AB1′} between the attribute of the product and the corresponding attribute of the associated product and the relative support value W_{A1′} of the attribute of the product. The absolute support value W_{AB1} between the attribute of the product and the corresponding attribute of the associated product is the number of attribute transactions in the aggregated set of attribute transactions that include the attribute of the product and the corresponding attribute of the associated product, while the relative support W_{AB1′} is the ratio of the number of attribute transactions that include the attribute of the product and the corresponding attribute of the associated product to the total number of attribute transactions. The absolute support value of the corresponding attribute of the associated product W_{B1} is the number of attribute transactions aggregated set of attribute transactions that include the corresponding attribute of the associated product; the relative support value of the attribute of the associated product W_{B1′} is the ratio of the number of attribute transactions that include the attribute of the associated product to the total number of attribute transactions aggregated set of attribute transactions.

In various embodiments, the comprehensive correlation degree between a product and each of the other products that appear in at least one of the same product transactions (these other products is each referred to as an associated product) are determined offline for the product (e.g., prior to when such comprehensive correlation degree information is used). So, for each product, a comprehensive correlation degree between the product and every associated product in an aggregated set of product transactions is determined and stored prior to generating product recommendations. As such, when user operation triggers a generation of product recommendations, the stored comprehensive correlation degree information for a product and every associated product can be retrieved and used to generate the product recommendations.

In various embodiments, the generation of product recommendations no longer relies on the confidence levels of a product with respect to other products. Instead, the generation of product recommendations relies on the comprehensive correlation degree between a product and each associated product of the same aggregated set of product transactions. Because the comprehensive correlation degree between a product and an associated product is determined based on not only the degree of correlation of product information but also on the degree of correlation of attribute information, the comprehensive correlation degree is able capture the associations between different products that are associated with similar user behavior (e.g., two products that were purchased by the product during the same period of time) through the degree of correlation between product information but also the similarities between the attributes (of one or more types) of the products. It is useful to consider the similarities between the attributes of products because some products, despite the low probability of their being purchased, saved to favorites, or browsed at the same time as the product that is of interest to the user (e.g., a product that has been purchased by the user), may have some attributes in common with the product of interest to the user. For example, if when all the products in a set of product transactions are sorted according to place of origin, all the products could be the same place, which would make it difficult to determine correlation between products of that product transaction. That is to say, the correlation among these products is not very high, but the correlation between the attributes of these products may be very high, which indicates that at least some products of this set of product transactions may facilitate in generating product recommendations to users interested in products that are correlated to those products by virtue of their attributes.

At 308, a subset of the plurality of associated products is selected based at least in part on a condition associated with the corresponding plurality of comprehensive correlation degrees.

After the comprehensive correlation degree is determined for each individual associated product for the product associated with the user operation of the aggregated set of product transactions, then those associated products whose comprehensive correlation degrees meet predetermined criteria are selected.

For example, the predetermined criteria can include: the comprehensive correlation degree being not less than a specified threshold value.

In another example, the predetermined criteria can also include selecting the first N number of comprehensive correlation degrees in a list of ranked comprehensive correlation degrees of all associated products. N can be a predetermined number.

At 310, the subset of plurality of associated products is presented.

In some embodiments, the selected associated products for the product can be presented to the user in a display (e.g., of images and/or text) at the electronic commerce website.

In some embodiments, besides determining the association degree of product information and the association degree of attribute information based on reliability and support values, the association degree of product information and the association degree of attribute information can be also determined using other statistical measures and support values. For example, they can be determined based on coverage and support values or based on lift and support values. Examples of how coverage and lift values are determined between the product A and an associated product B.

The coverage value between the product A and the associated product B can be determined by one of the following two determination methods, for example:

Method 1: rAB/rB, meaning the absolute support rAB between the product A and the associated product B is divided by the absolute support rB of the associated product B.

Method 2: rAB′/rB′, meaning the relative support rAB′ between the product A and the associated product B is divided by the relative support rB′ of the associated product B.

The lift value between the product A and the associated product B can be determined by one of the following two determination methods, for example:

Method 1: rAB/rA/rB, meaning the absolute support rAB between the product A and the associated product B is divided by the absolute support rA of the product A and then divided by the absolute support rB of the associated product B.

Method 2: rAB′/rA′/rB′, meaning the relative support rAB′ between the product A and the associated product B is divided by the relative support rA′ of the product A and then divided by the relative support rB′ of the associated product B.

If, to determine an association degree of product information and an association degree of attribute information, the reliability value as a statistical measure is replaced by the coverage value, then the product information association degree between the product A and the associated product B can be determined using the coverage and support values between the product A and the associated product B, while the attribute association degree between the attribute information of the product A and the corresponding attribute information of the associated product B is determined using the coverage and support values between the attribute information of the product A and the attribute information of the associated product B.

If, to determine an association degree of product information and an association degree of attribute information, the reliability value as a statistical measure is replaced by the lift value, then the product information association degree between product A and associated product B can be determined using the lift and support values between product A and associated product B, while the attribute information association degree between an attribute of product A and the attribute of associated product B is determined based on the lift and support values between the attribute of the product A and the corresponding attribute of associated product B.

By conventional techniques, the candidate frequent 1-itemsets whose relative support value is no smaller than a specified threshold value are selected as confirmed frequent 1-itemsets, while the candidate frequent 2-itemsets whose relative support values is no smaller than the another specified threshold value are selected as confirmed frequent 2-itemsets. Selections of confirmed frequent 1-itemsets and 2-itemsets are based on confidence levels. In other words, first, multiple screenings are carried out according to relative support values and then screening is carried out according to confidence levels, whereby some products whose confidence is high but whose relative support is not high can be filtered out. However, this could lead to a loss of some product information with a strong correlation. To address this issue, using the techniques disclosed in the present application, frequent 1-itemsets and frequent 2-itemsets will no longer need to be selected based on relative support values or absolute support values. That is, using the techniques disclosed in the present application, product information of one product in a product transaction will constitute a product 1-itemset, while two product information of two products included in the same product transaction will constitute a product 2-itemset. So, ultimately, when selecting and recommending product information, the selection is performed based on the multiplication product of support (absolute support or relative support) values and reliability values, to avoid the potential loss of some product information with high correlations.

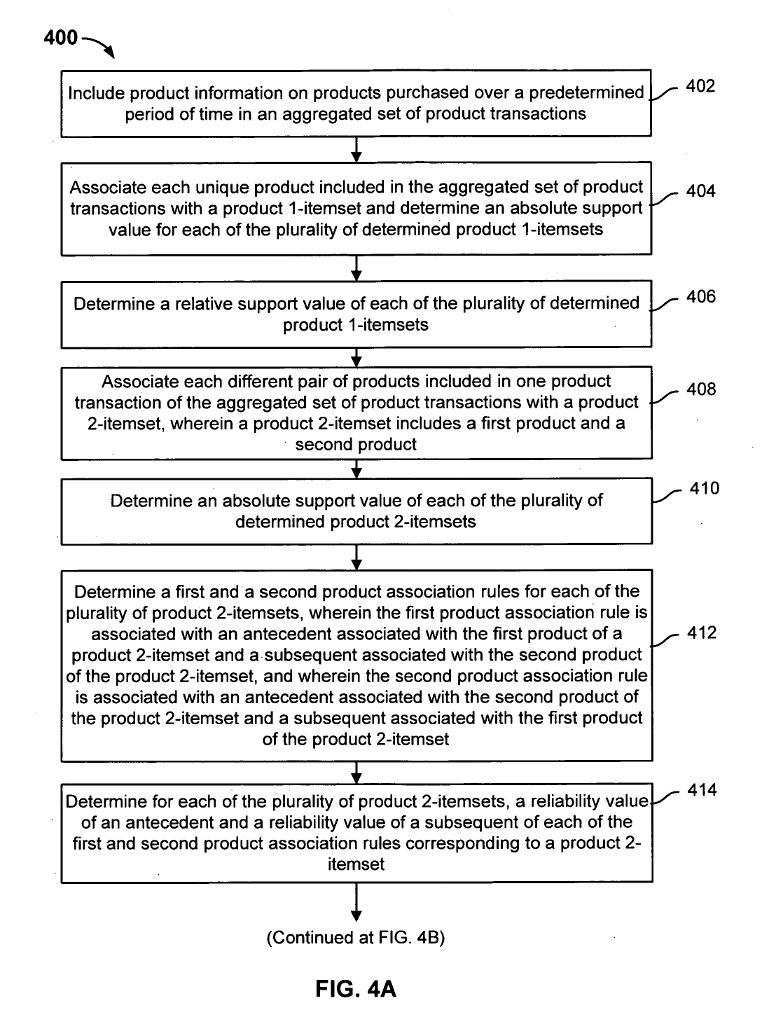

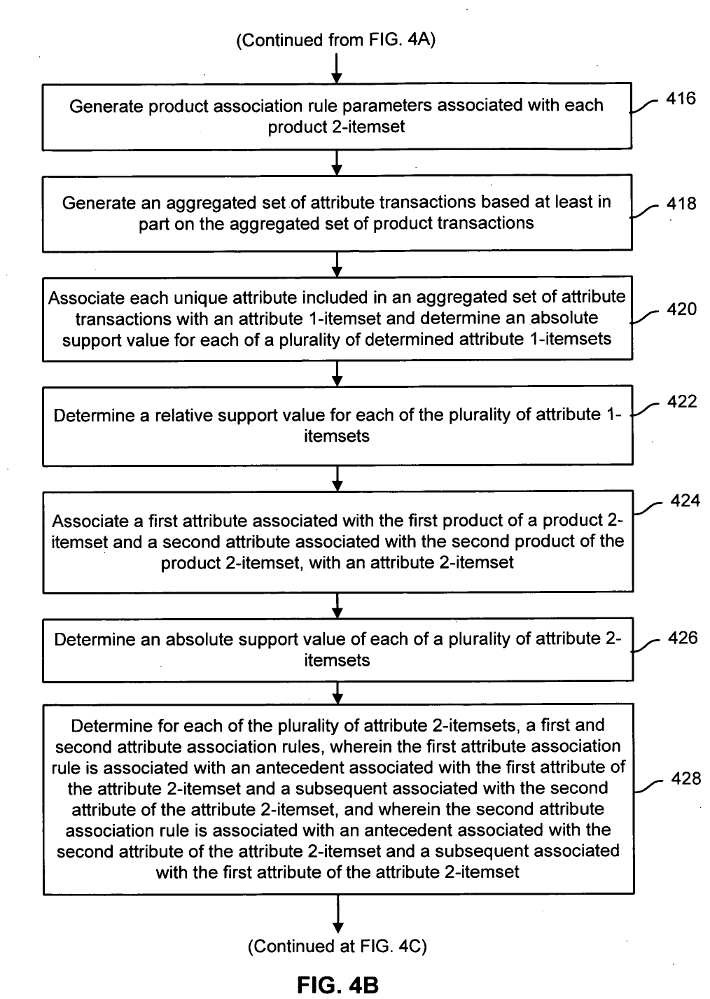

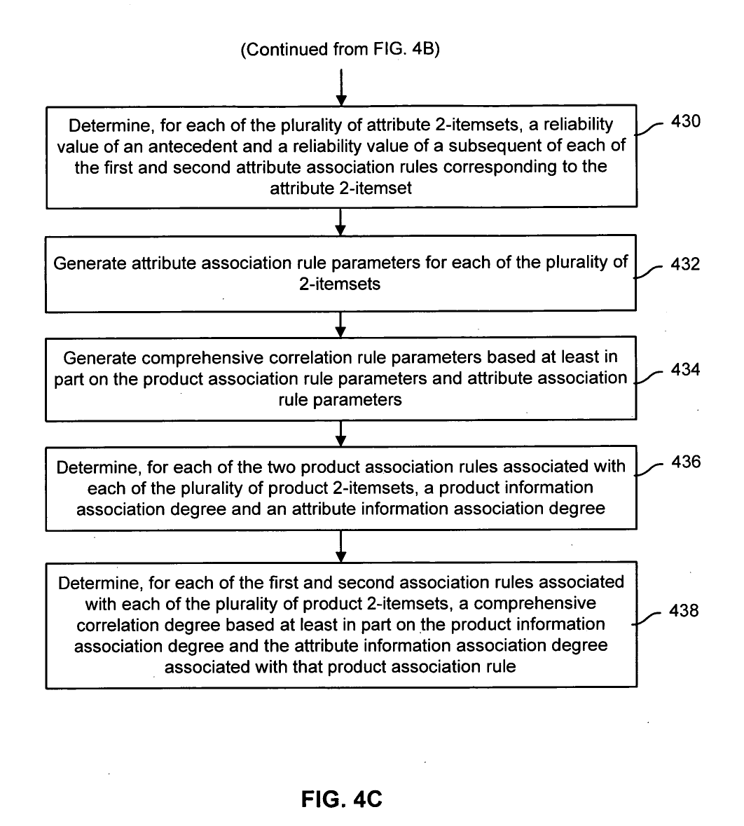

FIG. 4 is a flow diagram showing an embodiment of a process of generating comprehensive correlation degrees. In some embodiments, process 400 can be used to implement at least a portion of process 300. In some embodiments, process 400 can be performed offline to provide information (e.g., comprehensive correlation degrees) that can be used to generate product recommendations. In some embodiments, process 400 can be implemented on system 200.

At 402, product information on products purchased over a predetermined period of time is included into an aggregated set of product transactions.

In various embodiments, the product information on products purchased by one or more users at an electronic commerce website are stored on a transaction database server. Product information can include, for example, unique identifiers associated with different types of products, timestamps associated with the times that the products were purchased, and identifiers associated with the users who purchased the products. In some embodiments, the products that are included in one product transaction were not necessarily purchased during the same checkout session; instead, a product transaction can be defined in one of the ways mentioned at 304 of process 300.

The following is an example of creating product transactions: First, product information of products purchased and purchase time by one or more users over a predetermined period of time are retrieved from the transaction database server. In some embodiments, the predetermined period of time can be set (e.g., a fiscal quarter in a year), and the transaction database server can be searched for stored information of purchased products whose purchase timestamps fall within the predetermined period of time. For example, the predetermined period of time can be one year ago from the current date. Each set of retrieved product information and purchase timestamps can be stored in a data table in, for example, the following format: <user identifier, purchase time, product identifier>. This data table is referred to as the RE table. In some embodiments, if the data of the RE table is not already organized into individual product transactions, the data is separated into each product transaction, which can be stored, for example, in the following format: <user identifier, purchase time, product identifier>, and this data table is referred to as the TP data table. In some embodiments, a data table refers to a table or some kind of data structure that can be used to store data.

In various embodiments, the set of product transactions that are created from the retrieved product information associated with the predetermined period of time are referred to as an aggregated set of product transactions. The aggregated set of product transactions can be analyzed offline to determine correlations between the products mentioned in the aggregated set.

At 404, each unique product included in the aggregated set of product transactions is associated with a product 1-itemset and an absolute support value is determined for each of the plurality of determined product 1-itemsets.

Each unique type of product in the aggregated set of product transactions is associated with a product 1-itemset. The absolute support value for each product 1-itemset is the number of product transactions in the aggregated set of product transactions that include the product associated with the product 1-itemset. A product 1-itemset refers to a set of products that includes only one product.

In some embodiments, the absolute support value of each product 1-itemset can be stored in a data table based on, for example, the following format: <product identifier, absolute support value>. This data table can be referred to as the OneIAS table.

At 406: the relative support value of each of the plurality of determined product 1-itemsets is determined.

The relative support value of each product 1-itemset is the ratio of its absolute support value to the total number of product transactions in the aggregated set of product transactions. The relative support value of each product 1-itemset can be stored in a data table based on, for example, the following format: <product identifier, relative support value>. This data table can be referred to as the OneIS table.

At 408: each different pair of products included in one product transaction of the aggregated set of product transactions is associated with a product 2-itemset, wherein a product 2-itemset includes a first product and a second product.

Every pair of different products from the same product transaction of the aggregated set of product transactions is associated with a product 2-itemset. Put another way, a product 2-itemset can be thought of to include two different products that are each associated with a different 1-itemset and both belong to the same product transaction. More than one product transaction can include the same product 2-itemset. Also, one product transaction can also include more than 1 type of product 2-itemset.

Each product 2-itemset can be stored in the data table based, for example, on the following format: <product identifier A, product identifier B>. This data table is referred to as TwoIS table, where the product identifier A is associated with product A, and the product identifier B is associated with product B.

For example, one product transaction can be represented by <user a, first fiscal quarter, A, B, D, F> (where A, B, D, and F are products). The product 2-itemsets that can be created from this product transaction include {A, B}, {A, D}, {A, F}, {B, D}, {B, F}, and {D, F}. However, {A, Q} is not a 2-itemset (at least not one that is associated with this product transaction) because not both of products A and Q are found in this product transaction. Another product transaction can be represented by <user b, first fiscal quarter, D, B, H, J> and so the product 2-itemsets that can be created from this product transaction include {D, B}, {D, H}, {D, J}, {B, H}, {B, J}, and {H, J}. Note that that the product 2-itemset of {D, B} (note that {D, B} and {B, D} are two ways of representing the same product 2-itemset) is associated with both product transactions.

At 410, the absolute support value of each product 2-itemset is determined for each of a plurality of determined product 2-itemsets.

The absolute support value of each product 2-itemset is the number of product transactions of the aggregated set of product transactions that include both of the two products associated with the product 2-itemset. The absolute support value of each product 2-itemset can be stored in a data table based on, for example, the following format b: <product identifier A, product identifier B, absolute support value AB>. This data table is referred to as the TwoIAS table.

At 412, a first and a second association rules are determined for each of the plurality of product 2-itemsets, wherein the first product association rule is associated with an antecedent associated with the first product of the product 2-itemset and a subsequent associated with the second product of the product 2-itemset, and wherein the second product association rule is associated with an antecedent associated with the second product of the product 2-itemset and a subsequent associated with the first product of the product 2-itemset.

For example, each product 2-itemset {A, B} corresponds to two product association rules: 1) a first product association rule is associated with A→B, where A is the antecedent, B is the subsequent, and B is an associated product of A and 2) a second product association rule is associated with B→A, where B is the antecedent, A is the subsequent, and A is the associated product of B. The confidence level of an antecedent and a subsequent in each product association rule is the ratio of the absolute support value of the corresponding product 2-itemset to the absolute support value of the antecedent. For example, for the product association rule of A→B, the confidence level of antecedent A and subsequent B (associated product to A) is the ratio of the absolute support value of the product 2-itemset {A, B} (i.e., the number of product transactions in the aggregated set of product transactions that include both of the two products of the product 2-itemset) to the absolute support value of A (i.e., the number of product transactions in the aggregated set of product transactions that include the product A or rather, the absolute support value of the 1-itemset associated with product A); for the product association rule of B→A, the confidence level of antecedent B and subsequent A (associated product to B) is the ratio of the absolute support value of the product 2-itemset {A, B} (i.e., the number of product transactions in the aggregated set of product transactions that include the two products of the product 2-itemset) to the absolute support value of B (i.e., the number of product transactions in the aggregated set of product transactions that include the product A or rather, the absolute support value of the 1-itemset associated with product B). The two confidence levels corresponding to the product 2-itemset {A, B} can be stored in a data table based on, for example, the following format: <product identifier A, product identifier B, confidence AB, confidence BA>. This data table can be referred to as TwoIConf table, where confidence AB is the confidence level of antecedent product A and subsequent product B, while confidence BA is the confidence level of antecedent product B and subsequent product A.

At 414, for each of the plurality of product 2-itemsets, a reliability value of an antecedent and a reliability value of a subsequent of each of the first and second product association rules corresponding to the product 2-itemset are determined.

The reliability value of the antecedent and subsequent of an product association rule is the difference between the confidence level of the antecedent and subsequent and the relative support value of the subsequent. For example, for the product association rule of A→B, the reliability value of A and B is the difference between the confidence level of A and B and the relative support value of B, while for the product association rule of B A, the reliability value of B and A is the difference between the confidence level of B and A and the relative support value of A. The corresponding two reliability values of the product 2-itemset {A, B} can be stored in a data table based on, for example, the following format: <product identifier A, product identifier B, reliability value AB, reliability value BA>, and this data table can be referred to as TwoIRel table, where reliability value AB is the reliability value of antecedent product identifier A and subsequent product identifier B, while reliability value BA is the reliability value of antecedent product identifier B and subsequent product identifier A.

At 416, product association rule parameters associated with each product 2-itemset are generated.

In some embodiments, the TwoIRel table and the TwoIAS table can be retrieved (e.g., from storage) to obtain the product association rules, corresponding absolute support values, and corresponding reliability values for each product 2-itemset to generate product association rule parameters for each product 2-itemset. For example, product association rule parameters can be stored in a data table based, for example, on the following format: <product identifier A, product identifier B, absolute support value AB, absolute support value BA, reliability value AB, reliability value BA>. This data table can be referred to as PAR table.

At 418: an aggregated set of attribute transactions is generated based at least in part on the aggregated set of product transactions.

In some embodiments, each product transaction of the aggregated set of product transactions can be transformed into one or more attribute transactions (e.g., wherein each attribute transaction is associated with one type of attribute such as brand, effect, or origin). An attribute transaction can be stored in a data table based, for example, on the following format: <user identifier, quarter identifier, attribute identifier(s)>, where the user identifier is associated with the user who performed the product purchase(s) associated with the product transaction from which the attributes identified by the attribute identifier(s) were found and where the quarter identifier identifies the predetermined period of time with which the product transaction is associated. This data table can be referred to as the TP1 table.

In some embodiments, each type attribute associated a product transaction is included into a separate attribute transaction. For example, a product transaction can be represented by <user a, first fiscal quarter, A, B, D, F>. Each of products A, B, D, and F can be associated with one or more types of attributes (e.g., effect attributes, brand attributes, place of origin attributes). Each type of attribute can be associated with various attribute values, attribute identifiers or categories. A product transaction can be transformed based on one type of attribute to create an attribute transaction. If the product transaction <user a, first fiscal quarter, A, B, D, F> were transformed based on the attribute type of brand attributes, then the resulting attribute transaction can be represented as <user a, first fiscal quarter, attribute identifier 1, attribute identifier 3, attribute identifier 3, attribute identifier 8>, where product A is associated with the brand attribute of attribute identifier 1, product B is associated with the brand attribute of attribute identifier 3, product D is associated with the brand attribute of attribute identifier 3, product F is associated with the brand attribute of attribute identifier 8. A product transaction can be transformed based on each type of multiple attributes to yield multiple attribute transactions from each product transaction.

In various embodiments, the set of attribute transactions that are created from the product transactions of the aggregated set of product transactions associated with the predetermined period of time is referred to as an aggregated set of attribute transactions.

At 420, each unique attribute included in an aggregated set of attribute transactions is associated with an attribute 1-itemset and an absolute support value is determined for each of the plurality of determined attribute 1-itemsets.

Each unique attribute (e.g., attribute identifier) in the aggregated set of attribute transactions is associated with an attribute 1-itemset. The absolute support value for each attribute 1-itemset is the number of attribute transactions in the aggregated set of attribute transactions that include the attribute associated with the attribute 1-itemset. An attribute 1-itemset refers to a set of attributes that includes only one attribute.

At 422, a relative support value of each of the plurality of attribute 1-itemsets is determined.

The relative support value of each attribute 1-itemset is the ratio of its absolute support value to the total number of attribute transactions in the aggregated set of attribute transactions.

At 424, a first attribute associated with the first product of a product 2-itemset and a second attribute associated with the second product of the product 2-itemset are associated with an attribute 2-itemset.

In various embodiments, the first attribute and the second attribute are attribute identifiers associated with the same/corresponding type of attribute. In some embodiments, 424 can be performed once (e.g., for one attribute from a first product and a corresponding attribute of the associated product of a product 2-itemset) for each product 2-itemset. In some embodiments, 424 can be repeated for every type of attribute that is associated with both of the first and second products of a product 2-itemset, for each of the determined product 2-itemsets. However, for exemplary purposes, for the remainder of the discussion of process 400, 424 is performed for only one type of attribute (e.g., attribute a of product A and attribute b of product B is associated with same type of attribute).

For example, for attribute 2-itemset {a, b}, attribute a can be associated with product A of product 2-itemset {A, B}, and attribute b can be associated with product B of product 2-itemset {A, B} (or attribute b can be associated with product A of product 2-itemset {A, B}, and attribute a can be associated with product B of product 2-itemset {A, B}).

At 426: an absolute support value is determined for each of a plurality of attribute 2-itemsets.

The absolute support value of an attribute 2-itemset is the number of attribute transactions of the aggregated set of attribute transactions that include the two attributes of the attribute 2-itemset.

At 428, a first and second attribute association rules are determined for each of the plurality of attribute 2-itemsets, wherein the first attribute association rule is associated with an antecedent associated with the first attribute of the attribute 2-itemset and a subsequent associated with the second attribute of the attribute 2-itemset, and wherein the second attribute association rule is associated with an antecedent associated with the second attribute of the attribute 2-itemset and a subsequent associated with the first attribute of the attribute 2-itemset.

For example, each attribute 2-itemset {a, b} corresponds to two attribute association rules: 1) a first attribute association rule is associated with of a→b, where a is the antecedent, b is the subsequent, and b is an associated attribute of a and 2) a second attribute association rule is associated with b→a, where b is the antecedent, a is the subsequent, and a is the associated attribute of b. The confidence level of an antecedent and a subsequent in each attribute association rule is the ratio of the absolute support value of the corresponding attribute 2-itemset to the absolute support value of the antecedent. For example, for a→b, the confidence level of antecedent a and subsequent b (associated attribute to a) is the ratio of the absolute support value of the attribute 2-itemset {a, b} (i.e., the number of attribute transactions in the aggregated set of attribute transactions that include the two attributes of the attribute 2-itemset) to the absolute support value of a (i.e., the number of attribute transactions in the aggregated set of attribute transactions that include the attribute a or rather, the absolute support value of the 1-itemset associated with attribute a); for b→a, the confidence level of antecedent b and subsequent a (associated attribute to b) is the ratio of the absolute support value of the attribute 2-itemset {a, b} (i.e., the number of attribute transactions in the aggregated set of attribute transactions that include the two attributes of the attribute 2-itemset) to the absolute support value of b (i.e., the number of attribute transactions in the aggregated set of attribute transactions that include the attribute b or rather, the absolute support value of the 1-itemset associated with attribute b). The two confidence levels corresponding to the attribute 2-itemset {a, b} can be stored in a data table based, for example, on the following format: <attribute identifier a, attribute identifier b, confidence ab, confidence ba>. This data table can be referred to as TwoIConf table, where confidence ab is the confidence level of antecedent attribute a and subsequent attribute b, while confidence ba is the confidence level of antecedent attribute b and subsequent attribute a.

At 430, for each of the plurality of attribute 2-itemsets, a reliability value of an antecedent and a reliability value of a subsequent of each of the first and second attribute association rules corresponding to the attribute 2-itemset are determined.

The reliability value of the antecedent and subsequent of an attribute association rule is the difference between the confidence level of the antecedent and subsequent and the relative support value of the subsequent. For example, for the attribute association rule of a→b, the reliability value of a and b is the difference between the confidence level of a and b and the relative support value of b, while for the attribute association rule of b→a, the reliability value of b and a is the difference between the confidence level of b and a and the relative support value of a. The reliability value ab is the reliability value of antecedent attribute a and subsequent attribute b, while reliability value ba is the reliability value of antecedent attribute identifier b and subsequent attribute identifier a.

At 432, attribute association rule parameters associated for each of the plurality of attribute 2-itemsets are generated.

Attribute association rule parameters can be stored in a data table based, for example, on the following format: <attribute identifier a, attribute identifier b, absolute support value ab, absolute support value ba, reliability value ab, reliability value ba>. This data table can be referred to as the CAR table. In the CAR table, the attribute identifier a is an attribute corresponding to product A, the attribute identifier b is an attribute corresponding to product B of a product 2-itemset {A, B}, the absolute support value ab is the absolute support value of the attribute identifier a and the attribute identifier b, while the absolute support value ba is the absolute support value of the attribute identifier b and the attribute identifier a; the reliability value ab is the reliability value of antecedent attribute identifier a and subsequent attribute identifier b, while the reliability value ba is the reliability value of antecedent attribute identifier b and subsequent attribute identifier a.

At 434, comprehensive correlation rule parameters are generated based at least in part on the product association rule parameters and the attribute association rule parameters.

In some embodiments, the product association rule parameters can be merged with the attribute association rule parameters to generate the comprehensive correlation rule parameters. For example, each set of attribute association rule parameters can be merged with the product association rule parameters of the related product 2-itemset. Therefore, in some embodiments, there could be a many comprehensive correlation rule parameters associated with a product 2-itemset as there are attribute transactions associated with the product 2-itemset. Comprehensive correlation rule parameters can be stored in a data table based on, for example the following format: <product identifier A, product identifier B, attribute identifier a, attribute identifier b, absolute support value AB, absolute support value BA, reliability value AB, reliability value BA, absolute support value ab, absolute support value ba, reliability value ab, reliability value ba>. This data table can be referred to as PArC table.

At 436, for each of first and second product association rules associated with each of the plurality of product 2-itemsets, a product information association degree and an attribute information association degree is determined.

For the product association rule of A→B, the product information association degree of A and B is=(absolute support value AB)×(reliability value AB). For the product association rule of B→A, the product association degree of B and A is=(absolute support value BA)×(reliability value BA). For the product association rule of A B, the attribute information association degree of A and B is: (absolute support value ab)×(reliability value ab). For the product association rule of A→B, the attribute association degree of A and B is=(absolute support value ab)×(reliability value ba).

At 438, for each of the first and second product association rules associated with each of the plurality of product 2-itemset, a comprehensive correlation degree is determined based at least in part on the product information association degree and attribute information association degree associated with that product association rule.

As mentioned above, the comprehensive correlation degree for each of two product association rules associated with a product 2-itemset can be determined using the following techniques, for example: multiplying the product information association degree and attribute information association degree, adding the product information association degree and attribute information association degree, or attributing a weight coefficient to each of the product information association degree and attribute information association degree and then adding the weighted values together, or attributing a weight coefficient to each of product information association degree and attribute information association degree and then averaging the weighted values.

In various embodiments, the comprehensive correlation degree for each production association rule (e.g., A→B and B→A) are stored such that the comprehensive correlation degree between a antecedent product (A) and each subsequent/associated product (B, C, D . . . etc) can be later recalled to make product recommendations.

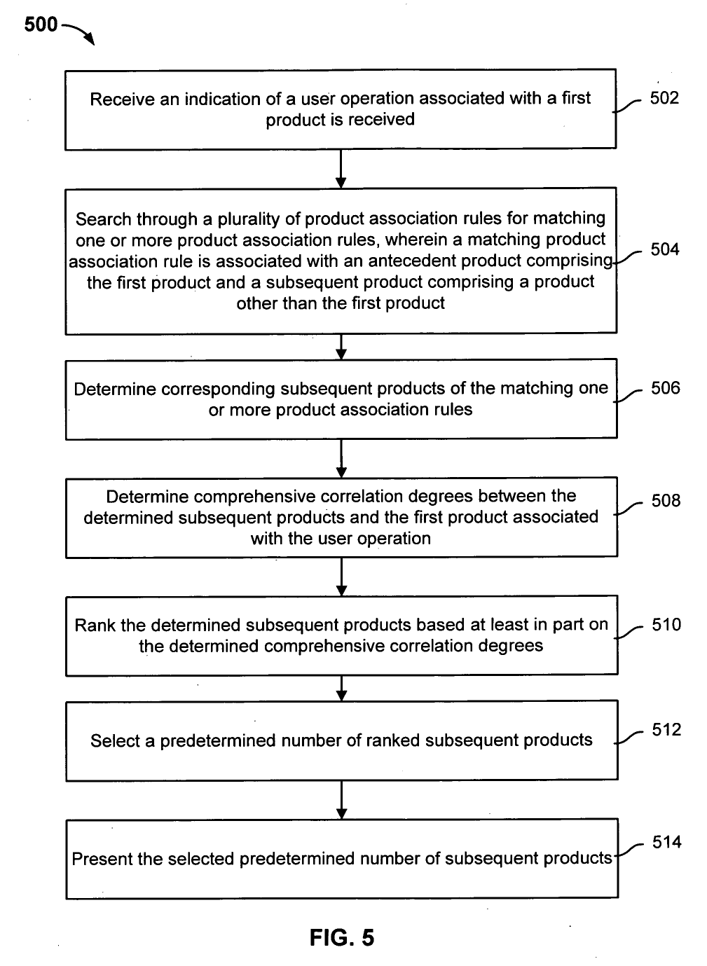

FIG. 5 is a flow diagram showing an embodiment of a process of generating product recommendations. In some embodiments, process 500 can be implemented after at least one iteration of process 400. In some embodiments, process 500 can be implemented at system 200.

At 502, an indication of a user operation associated with a first product is received.

Examples of the user operation can include browsing a webpage associated with the product at an electronic commerce website (e.g., using a web browser), purchasing the product at the website, or submitting feedback associated with the product at the website. For example, if a user is browsing at the webpage associated with the product of a printer ink cartridge, then an indication the user operation associated with a printer ink cartridge is received.

At 504, a plurality of product association rules is searched for matching one or more product association rules, wherein a matching product association rule is associated with an antecedent product comprising the first product and a subsequent product comprising a product other than the first product.

For example, the product association rules that were determined in process 400 can be stored and searched to find those rules whose antecedent includes the first product associated with the user operation and whose subsequent product is a product other than the first product. Assume that product A were associated with the user operation (e.g., a user browsed at a webpage that was associated with product A). Then, the stored product association rules can be searched for those rules that have product A as the antecedent. Examples of such matching rules can include A→B, A→C, A→F, A→W, . . . etc, where each of subsequent product B, C, F, and W is a product different than A.

At 506, corresponding subsequent products of the matching one or more product association rules are determined.

For example, the subsequent products of those rules whose antecedent includes the first product associated with the user operation are determined. Returning to the previous example where the stored product association rules were searched for those with product A as the antecedent, at least subsequent products B, C, F, and W of the matching A→B, A→C, A→F, and A→W product association rules are determined to correspond to antecedent product A.

At 508, comprehensive correlation degrees between the determined subsequent products and the first product associated with the user operation are determined.

In some embodiments, the comprehensive correlation degree between the first product associated with the user operation and a subsequent product of a product association rule is already determined and stored (e.g., during process 400). So, the comprehensive correlation degree between the first product associated with the user operation and each determined subsequent product can be retrieved from storage. For example, continuing the previous example, a comprehensive correlation degree for each of A→B, A→C, A→F, and A→W product association rules can be retrieved from storage.

At 510, the determined subsequent products are ranked based at least in part on the determined comprehensive correlation degrees.

In some embodiments, the determined subsequent products are ranked based on their respective comprehensive correlation degrees to form a list of subsequent products associated with comprehensive correlation degrees from the highest to lowest value.

At 512, a predetermined number of ranked subsequent products are selected.

In some embodiments, the first N of the ranked list of subsequent products are selected from the end of the list associated with the highest comprehensive correlation degree value. Returning to the previous example, assume that the based on their respective comprehensive correlation degrees, subsequent products are ranked (from the highest to lowest comprehensive correlation degree value) as W, F, B, and C. Assume that in this example, the first 3 subsequent products are selected from the beginning of the list. Thus, products W, F, and B are selected. These products are considered to be potentially the most desirable to a user who has shown an interest in (by virtue of performing a user operation associated with) product A.

At 514, the selected predetermined number of subsequent products are presented.

The selected products are presented as recommended products. Continuing the previous example, products W, F, and B are presented at the electronic website to the user who performed the user operation associated with product A. The recommended products can be presented as text and/or images. A presentation of a recommended product can also include a link to a webpage associated with the recommended product.

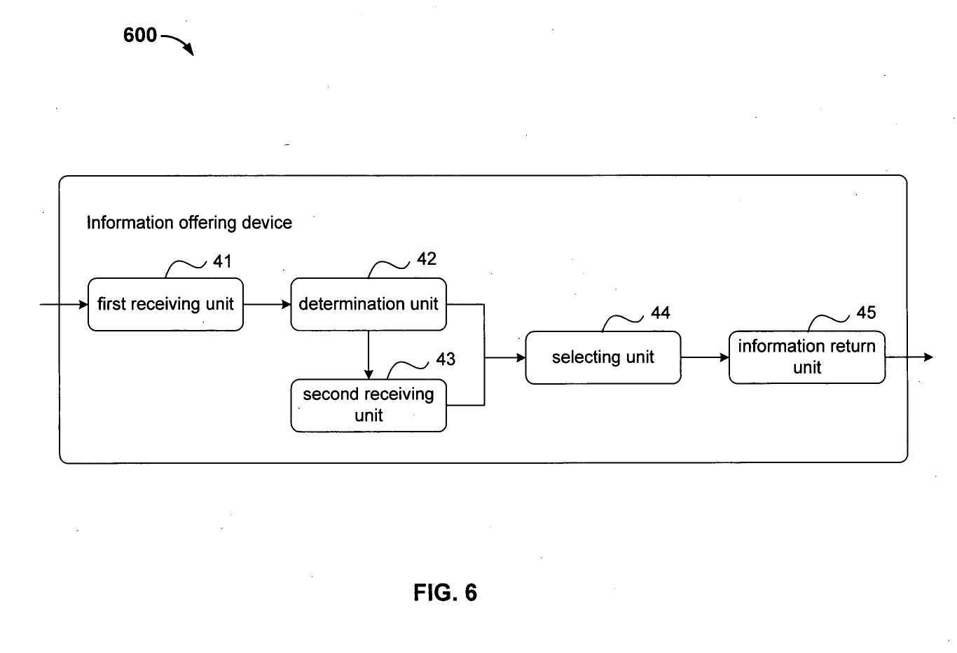

FIG. 6 is a diagram showing an embodiment of a system for generating product recommendations.

The units, subunits, modules, and submodules can be implemented as software components executing on one or more processors, as hardware such as programmable logic devices and/or Application Specific Integrated Circuits designed to perform certain functions or a combination thereof. In some embodiments, the units, subunits, modules, and submodules can be embodied by a form of software products which can be stored in a nonvolatile storage medium (such as optical disk, flash storage device, mobile hard disk, etc.), including a number of instructions for making a computer device (such as personal computers, servers, network equipments, etc.) implement the methods described in the embodiments of the present invention. The units, subunits, modules, and submodules may be implemented on a single device or distributed across multiple devices.

System 600 includes first receiving unit 41, determination unit 42, second receiving unit 43, selecting unit 44, and information return unit 45.

First receiving unit 41 is configured to receive an indication of a user operation associated with a product.

Determination unit 42 is configured to determine individual associated product information of the product associated with user operation, the indication of which was received by first receiving unit 41.

Second receiving unit 43 is configured to receive, for each associated product determined by determination unit 42, the comprehensive correlation degree between the product associated with the user operation and the associated product. The comprehensive correlation degree can be determined by a comprehensive correlation degree determination unit (not shown) based on the product information association degree and the attribute information association degree between the product associated with the user operation and the associated product.

Selecting unit 44 is configured to select, from the associated products determined by determination unit 42, the associated products with the corresponding comprehensive correlation degree that meets one or more preset conditions.

Information return unit 45 is configured to return the associated products selected by selecting unit 44.

In various embodiments, determination unit 42 is configured to include the information associated with the product of the user behavior received by first receiving unit 41 in a product transaction, wherein a product transaction is analyzed for generating recommendations if it is associated with a timestamp that is during a predetermined period of time.

In some embodiments, a user behavior can, for example, include at least one of the following: a user's purchase confirmation behavior, a user's addition of product information to the favorites folder behavior, and a user's browsing of a product behavior.

In various embodiments, the comprehensive correlation degree determination unit comprises the first determination subunit, the second determination subunit, the third determination subunit (not shown). Further explanations of the subunits are as follows:

The first determination subunit is configured to determine the product information association degree between a product and an associated product.

The second determination subunit is configured to determine the attribute association degree between the product and the associated product.

The third determination subunit is configured to determine the multiplication product of the product information association degree determined by the first determination subunit and the attribute information association degree determined by the second determination subunit to be the comprehensive correlation degree of the product and the associated product.

In various embodiments, the first determination subunit specifically comprises the first determination module, the second determination module, and the third determination module. Further explanations of the modules are as follows:

The first determination module is configured to determine the support value between a product and an associated product.

The second determination module is configured to determine the reliability value between the product and the associated product.

The third determination module is configured to determine the multiplication product of the support value determined by the first determination module and the reliability value determined by the second determination module as the product information association degree between the product and the associated product.

In various embodiments, the support value between the product and the associated product can be either the absolute support value or the relative support value between the product and the associated product.

In various embodiments, the second determination module comprises the first determination submodule and the second determination submodule. Further explanations of the submodules are as follows:

The first determination submodule is configured to determine a confidence level between a product and an associated product.

The second determination submodule is configured to determine the difference between the confidence level determined by the first determination submodule and the relative support value of the associated product to be the reliability value of the product and the associated product.

In various embodiments, the second determination subunit comprises a selection module, the fourth determination module, the fifth determination module, and the sixth determination module. Further explanations of the modules are as follows:

The selection module is configured to select at least one attribute from all the attributes of a product and an associated product.

The fourth determination module is configured to determine, for the attribute selected by the selection module, the support value between the attribute of the product and the corresponding attribute of the associated product.

The fifth determination module is configured to determine, for the attribute selected by the selection module, the reliability value between the attribute of the product and the corresponding attribute of the associated product.

The sixth determination module is configured to determine the multiplication product of individual support values determined by the fourth determination module and individual reliability values determined by the fifth determination module, to be the attribute information association degree between the attribute the product information and the corresponding attribute of the associated product.

In various embodiments, the support value between the attribute of the product and the corresponding attribute of the associated product can be either the absolute support value or the relative support value.

In various embodiments, the absolute support value between the attribute of the product and the corresponding attribute of the associated product is: the number of attribute transactions that simultaneously include the attribute of the product and the corresponding attribute of the associated product; the relative support value between the attribute of the product and the corresponding attribute of the associated product is: the ratio of the degree of absolute support value between the attribute of the product and the corresponding attribute of the associated product and the total number of attribute transactions (i.e., the aggregated set of attribute transactions, wherein the attribute of a product included in a product transaction is separated into one attribute transaction).

In various embodiments, the fifth determination module comprises the third determination submodule and the fourth determination submodule. Further explanations of the submodules are as follows:

The third determination submodule is configured to determine the confidence level between the attribute of the product and the corresponding of the associated product.

The fourth determination submodule is configured to determine the difference between the confidence level determined by the third determination submodule and the relative support value for the attribute of the associated product to be the reliability value between the attribute of the product and the corresponding attribute of the associated product.

In various embodiments, the preset conditions are: the comprehensive correlation degree is no smaller than a predetermined threshold value; or a first N number of comprehensive correlation degrees in a list of ranked comprehensive correlation degrees of all associated products. N can be a predetermined number.

In various embodiments, the information return unit 45 comprises a selection subunit and an information return subunit. Further explanations of the subunits are as follows:

The sequencing subunit is configured to arrange the rank and sequence of the selected associated product information selected by the selection unit 44 according to their comprehensive correlation degree in the order from high to low.

The information return subunit is configured to return the associated product information after the sequencing subunit has arranged the sequence.

Technical Experts in this field should understand that what the embodiments of the present disclosure can provide are methods, devices (equipment) or computer program products. Therefore, the present disclosure can adopt the form of purely hardware embodiments, purely software embodiments or embodiments that combine hardware aspects and software aspects. Moreover, the present disclosure can be utilized in the form of computer program products that are realized on one or multiple available computer storage media (including but not limited to magnetic memory, CD-ROM, optical memory, etc.) containing available computer program code.

This application is described with reference to flow charts and/or block diagrams that are based on the methods, devices (equipment) or computer program products of the embodiments of this application. It is understood that every procedure and/or block in the flow charts and/or block diagrams as well as combinations of procedures and/or blocks in the flow charts and/or block diagrams can be realized through computer program commands. These computer program commands can be delivered to multipurpose computers, special purpose computers, embedded processors or other processors of other programmable data processing devices to produce a machine that would make it possible to produce, through commands carried out by computers or processors of other programmable data processing devices, a device configured to realize the functions specified in one procedure or a plurality of procedures in the flowcharts and/or one block or a plurality of blocks in the block diagrams.

These computer program commands can also be stored in a computer readable memory that can guide the computer or another programmable data processing device to operate in a specified manner, such that the commands stored in the computer readable memory would generate products, including a command device, the command device realizing the functions specified in one procedure or a plurality of procedures in the flowcharts and/or one block or a plurality of blocks in the block diagrams.

These computer program commands can also be downloaded onto computers or other programmable data processing devices, such that a sequence of operation steps is carried out on the computer or another programmable data processing device to generate computer-realized processing, whereby the commands carried out on the computer or another programmable data processing device are provided for use in the realization of steps in the functions specified in one procedure or a plurality of procedures in the flowcharts and/or one block or a plurality of blocks in the block diagrams.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive an indication of a user operation associated with a product;
determine a plurality of associated products for the product associated with the user operation;
determine a plurality of comprehensive correlation degrees corresponding to the plurality of associated products, wherein each of the plurality of comprehensive correlation degrees corresponds to an association between the product and one of the plurality of associated products, wherein to determine a comprehensive correlation degree corresponding to the product and an associated product includes to:
determine a product information association degree corresponding to the product and the associated product; and
determine an attribute information association degree corresponding to the product and the associated product;
select a subset of the plurality of associated products based at least in part on a condition associated with the corresponding plurality of comprehensive correlation degrees; and
present the subset of the plurality of associated products; and
a memory coupled with the processor and configured to provide the processor with instructions.

2. The system of claim 1, wherein the user operation is associated with one of: browsing a webpage associated with the product, purchasing the product at a website, or submitting feedback associated with the product at the website.

3. The system of claim 1, wherein the processor is further configured to:
retrieve information on products purchased over a predetermined period of time; and
separate the information into a plurality of product transactions, wherein each product transaction is associated with at least two products.

4. The system of claim 3, wherein each of the plurality of associated products and the product associated with the user operation are both included in at least one of the plurality of product transactions.

5. The system of claim 4, wherein the processor is further configured to transform the plurality of product transactions into a plurality of attribute transactions.

6. The system of claim 4, wherein the product information association degree corresponding to the product and the associated product is determined based at least in part on 1) a support value between the product and the associated product and 2) a reliability value between product and the associated product.

7. The system of claim 6, wherein the support value between the product and the associated product comprises an absolute support value between the product and the associated product.

8. The system of claim 6, wherein the support value between the product and the associated product comprises a relative support value between the product and the associated product.

9. The system of claim 5, wherein attribute information association degree corresponding to the product and the associated product is determined based at least in part on an attribute of the product and a corresponding attribute of the associated product, 1) a support value between the attribute of the product and the corresponding attribute of the associated product, and 2) a reliability value between the attribute of the product and the corresponding attribute of the associated product.

10. The system of claim 1, wherein the comprehensive correlation degree between a product and an associated product is determined using one of the following: multiplying the product information association degree and attribute information association degree, adding the product information association degree and attribute information association degree, attributing a weight coefficient to each of the product information association degree and attribute information association degree and then adding the weighted values together, or attributing a weight coefficient to each of the product information association degree and the attribute information association degree and then averaging the weighted values.

11. The system of claim 1, wherein to select a subset of the plurality of associated products based at least in part on a condition associated with the corresponding plurality of comprehensive correlation degrees includes the processor configured to:
rank the plurality of comprehensive correlative degrees; and
select the subset of the plurality of associated products corresponding to a predetermined number of the ranked plurality of comprehensive correlative degrees.

12. The system of claim 1, wherein to select a subset of the plurality of associated products based at least in part on a condition associated with the corresponding plurality of comprehensive correlation degrees includes the processor configured to: select the subset of the plurality of associated products corresponding to comprehensive correlation degrees that are not less than a specified threshold value.

13. The system of claim 1, wherein to present the subset of the plurality of associated products includes to display the subset of the plurality of associated products using one of: text, images, or text and images.

14. A method, comprising:
receiving an indication of a user operation associated with a product;
determining a plurality of associated products for the product associated with the user operation;
determining a plurality of comprehensive correlation degrees corresponding to the plurality of associated products, wherein each of the plurality of comprehensive correlation degrees corresponds to an association between the product and one of the plurality of associated products, wherein determining a comprehensive correlation degree corresponding to the product and an associated product includes:
determining a product information association degree corresponding to the product and the associated product; and
determining an attribute information association degree corresponding to the product and the associated product;
selecting a subset of the plurality of associated products based at least in part on a condition associated with the corresponding plurality of comprehensive correlation degrees; and
presenting the subset of the plurality of associated products.

15. The method of claim 14, wherein the user operation is associated with one of: browsing a webpage associated with the product, purchasing the product at a website, or submitting feedback associated with the product at the website.

16. The method of claim 14, further comprising:
retrieving information on products purchased over a predetermined period of time; and
separating the information into a plurality of product transactions, wherein each product transaction is associated with at least two products.

17. The method of claim 16, wherein each of the plurality of associated products and the product associated with the user operation are both included in at least one of the plurality of product transactions.

18. The method of claim 17, further comprising transforming the plurality of product transactions into a plurality of attribute transactions.

19. The method of claim 17, wherein the product information association degree corresponding to the product and the associated product is determined based at least in part on 1) a support value between the product and the associated product and 2) a reliability value between product and the associated product.

20. The method of claim 19, wherein the support value between the product and the associated product comprises an absolute support value between the product and the associated product.

21. The method of claim 19, wherein the support value between the product and the associated product comprises a relative support value between the product and the associated product.

22. The method of claim 18, wherein attribute information association degree corresponding to the product and the associated product is determined based at least in part on an attribute of the product and a corresponding attribute of the associated product, 1) a support value between the attribute of the product and the corresponding attribute of the associated product, and 2) a reliability value between the attribute of the product and the corresponding attribute of the associated product.

23. The method of claim 14, wherein the comprehensive correlation degree between a product and an associated product is determined using one of the following: multiplying the product information association degree and attribute information association degree, adding the product information association degree and attribute information association degree, attributing a weight coefficient to each of the product information association degree and attribute information association degree and then adding the weighted values together, or attributing a weight coefficient to each of the product information association degree and the attribute information association degree and then averaging the weighted values

24. The method of claim 14, wherein selecting a subset of the plurality of associated products based at least in part on a condition associated with the corresponding plurality of comprehensive correlation degrees includes:
ranking the plurality of comprehensive correlative degrees; and
selecting the subset of the plurality of associated products corresponding to a predetermined number of the ranked plurality of comprehensive correlative degrees.

25. The method of claim 14, wherein selecting a subset of the plurality of associated products based at least in part on a condition associated with the corresponding plurality of comprehensive correlation degrees includes the processor configured to: select the subset of the plurality of associated products corresponding to comprehensive correlation degrees that are not less than a specified threshold value.

26. A computer program product, the computer program product being embodied in a computer readable storage medium and comprising computer instructions for:
receiving an indication of a user operation associated with a product;
determining a plurality of associated products for the product associated with the user operation;
determining a plurality of comprehensive correlation degrees corresponding to the plurality of associated products, wherein each of the plurality of comprehensive correlation degrees corresponds to an association between the product and one of the plurality of associated products, wherein determining a comprehensive correlation degree corresponding to the product and an associated product includes:
determining a product information association degree corresponding to the product and the associated product; and
determining an attribute information association degree corresponding to the product and the associated product;
selecting a subset of the plurality of associated products based at least in part on a condition associated with the corresponding plurality of comprehensive correlation degrees; and
presenting the subset of the plurality of associated products.
